(19) United States
(12) Patent Application Publication
(10) Pub. No.: US 2012/0170323 A1
(43) Pub. Date: Jul. 5, 2012

(54) CHARGING AC ADAPTOR

(75) Inventors: Jun IIDA, Kyoto (JP); Hiroyuki HATANO, Kyoto (JP); Kimitake UTSUNOMIYA, Tokyo (JP)

(73) Assignee: ROHM CO., LTD., Kyoto (JP)

(21) Appl. No.: 13/343,167

(22) Filed: Jan. 4, 2012

(30) Foreign Application Priority Data
Jan. 4, 2011 (JP) 2011-000248

(51) Int. Cl. H02M 3/335

(52) U.S. Cl. 363/16

(57) ABSTRACT

A charging AC adaptor includes: a first diode bridge connected to an AC terminal; a chopper controller connected to the first diode bridge; an insulating air core transformer connected to the chopper controller; a second diode bridge connected to a secondary side of the insulating air core transformer; a DC output terminal connected to the second diode bridge; and a common connection cable connected to the DC output terminal. The charging AC adaptor is connectable to a portable device via the common connection cable.

### CROSS-REFERENCE TO RELATED APPLICATIONS

This application is based upon and claims the benefit of priority from Japan Patent Application No. 2011-000248, filed on Jan. 4, 2011, the entire contents of which are incorporated herein by reference.

### TECHNICAL FIELD

The present disclosure relates to a charging AC adaptor, and more particularly, to a charging AC adaptor which can be used in common for various portable devices by using an insulating air core transformer formed on a printed circuit board.

### BACKGROUND

A schematic circuit configuration of a conventional charging AC adaptor with a dedicated cable connection, which uses an iron core insulating transformer (also called a magnetic core transformer), is shown in FIG. 11, and a schematic circuit configuration of a conventional charging AC adaptor of a chopper type charger using a high frequency transformer with a ferrite core is shown in FIG. 12.

As shown in FIG. 11, a conventional charging AC adaptor 24a includes a magnetic core transformer 13 connected to an AC terminal of, for example, AC 100 to 115 V or AC 200 to 240 V, a diode bridge 2 connected to a secondary side of the magnetic core transformer 13, a voltage stabilization circuit 3 connected to the diode bridge 2, and a DC output terminal 16 connected to the voltage stabilization circuit 3. The charging AC adaptor 24a may be connected to a portable device such as a notebook computer 20 or the like including, for example, a charging profile integrated circuit (IC) 14 via a dedicated cable 8a. An LED indicator 19 is only turned on during AC connection.

As shown in FIG. 12, an AC adaptor 24b includes a diode bridge 2 connected to an AC terminal of, for example, AC 100 to 115 V or AC 200 to 240 V, a chopper circuit 5 connected to the diode bridge 2 and having a chopper frequency fc, a ferrite core high frequency transformer 11 connected to the chopper circuit 5, a diode bridge 6 connected to a secondary side of the ferrite core high frequency transformer 11, a voltage detection circuit 9 connected to the diode bridge 6 and operating based on a band gap voltage reference, a DC output terminal 16 connected to the voltage detection circuit 9, and a photo-coupler 7 connected between the voltage detection circuit 9 and the chopper circuit 5 and that returns a voltage detection error signal of the voltage detection circuit 9 to the chopper circuit 5. The charging AC adaptor 24b is connected to a portable device such as a notebook computer 20 or the like including, for example, a charging profile IC 14 via a dedicated connector 8b. The conventional chopper type charging AC adaptor 24b is an accessory part of a portable device which is typically supplied as a package and is unusable when the portable device's life has ended.

In the conventional chopper type charging AC adaptor 24b, the ferrite core high frequency transformer 11 may become more compact with an increase in the chopper frequency fc. On the other hand, a power loss of a transistor arranged within the chopper circuit 5 and performing a switching operation with the chopper frequency is increased with an increase in the chopper frequency fc. Accordingly, the conventional chopper type charging AC adaptor 24b has a trade-off between the compactness of the ferrite core high frequency transformer 11 and the power loss of the transistor performing the switching operation with the chopper frequency, and was designed to provide an optimal trade-off

As a power supply system for supplying power to a mobile electronic apparatus such as a mobile phone, a notebook computer, a digital camera, an electronic toy or the like, there has been proposed a power supply system that can supply power to different kinds of electronic apparatuses by a single power transmitter (for example, see Japanese Patent Laid-Open Publication No. 2005-110409). The power supply system disclosed in Japanese Patent Laid-Open Publication No. 2005-110409 is composed of a power transmitter including a primary coil and a primary circuit that provides a pulse voltage, which is generated by switching a DC voltage obtained by rectifying commercial power, to the primary coil; and a portable telephone set including a secondary coil magnetically coupled to the primary coil and a secondary circuit that rectifies and smoothes an induction voltage induced to the secondary coil. A non-contact power supply system has also been proposed (for example, see Japanese Patent Laid-Open Publication No. 2006-211803, Japanese Patent Laid-Open Publication No. 2007-151264, Japanese Patent Laid-Open Publication No. 2002-118988, Japanese Patent Laid-Open Publication No. 2002-118988, Japanese Patent Laid-Open Publication No. 2007-312585, Japanese Patent Laid-Open Publication No. 2003-193717, Japanese Patent Laid-Open Publication No. 2001-019120, Japanese Patent Laid-Open Publication No. 2006-314151, and Japanese Patent Laid-Open Publication No. 2005-006459).

### SUMMARY

The present disclosure provides some embodiments of a charging AC adaptor which is capable of being used in common for various portable devices, such as mobile phone terminals, notebook computers, and so on, incorporating a charging battery and capable of maintaining power transmission efficiency and preventing a leakage magnetic flux from having an effect on mounted parts of the charging AC adaptor.

According to one embodiment of the present disclosure, there is provided a charging AC adaptor including: a first diode bridge connected to an AC terminal; a chopper controller connected to the first diode bridge; an insulating air core transformer connected to the chopper controller; a second diode bridge connected to a secondary side of the insulating air core transformer; a DC output terminal connected to the second diode bridge; and a common connection cable connected to the DC output terminal, wherein the charging AC adaptor may be connected to a portable device via the common connection cable.

### BRIEF DESCRIPTION OF THE DRAWINGS

FIG. 1 is a schematic circuit diagram of a charging AC adaptor to which an insulating air core transformer formed by a conductive pattern on a board is applied, according to an embodiment of the present disclosure.

FIG. 2A is a schematic perspective view of the insulating air core transformer applied to the charging AC adaptor according to the embodiment of the present disclosure.

FIG. 2B is an exemplary equivalent circuit diagram of FIG. 2A, with additional parallel resonance capacitors.

FIG. 2C is another exemplary equivalent circuit diagram of FIG. 2A, with additional parallel resonance capacitors.

FIG. 3A is a schematic plan view of a comparative example where a ferrite core high frequency transformer of a closed magnetic circuit is arranged on a board.

FIG. 3B is a schematic structural sectional view taken along line I-I in FIG. 3A.

FIG. 3C is a schematic plan view showing an arrangement of the insulating air core transformer which is formed by the conductive pattern on the board and is applied to the charging AC adaptor according to the embodiment of the present disclosure.

FIG. 3D is a schematic structural sectional view taken along line II-II in FIG. 3C.

FIG. 4A is a basic equivalent circuit diagram of the insulating air core transformer applied to the charging AC adaptor according to the embodiment of the present disclosure

FIG. 4B is a T type equivalent circuit diagram of FIG. 4A.

FIG. 4C is a Delta-Star transform equivalent circuit diagram of FIG. 4B.

FIG. 4D is a parallel resonance equivalent circuit diagram with additional parallel resonance capacitors.

FIG. 4E is a series resonance equivalent circuit diagram with an additional series resonance capacitor.

FIG. 4F is an equivalent circuit diagram with losses included to FIG. 4A.

FIG. 4G is an equivalent circuit diagram with losses included to FIG. 4B.

FIG. 4H is an equivalent circuit diagram with losses included to FIG. 4C.

FIG. 4I is an equivalent circuit diagram with losses included to FIG. 4D.

FIG. 4J is an equivalent circuit diagram with losses included to FIG. 4E.

FIG. 5A is an equivalent circuit diagram corresponding to FIG. 4F when winding reactance is X, a magnetic coupling coefficient between a primary coil and a secondary coil is k, and winding resistance is r in the insulating air core transformer applied to the charging AC adaptor according to the embodiment of the present disclosure

FIG. 5B is an equivalent circuit diagram when load resistor R is connected in the insulating air core transformer.

FIG. 6A is a view showing power transmission efficiency when load variation is 2W to 10 W in the insulating air core transformer applied to the charging AC adaptor according to the embodiment of the present disclosure.

FIG. 6B is a view showing power transmission efficiency when a magnetic coupling coefficient is changed from 0.8 to 2.0 in the insulating air core transformer.

FIG. 6C is a view showing power transmission efficiency when the number of winding turns n is changed from 4 to 6 in the insulating air core transformer.

FIG. 7 is an exemplary circuit diagram of the insulating air core transformer applied to the charging AC adaptor according to the embodiment of the present disclosure.

FIG. 8 is a view showing an example of the dimensions of the charging AC adaptor according to the embodiment of the present disclosure, a mobile phone to be charged, and a notebook computer to be charged.

FIG. 9 is a block diagram for explaining an aspect of bi-directional communication between the charging AC adaptor according to the embodiment of the present disclosure and a portable device.

FIG. 10A is a schematic explanatory view of a comparative example of portable device charging technique capable of wirelessly charging and driving a mobile phone and a notebook computer within a spherical surface having a radius of Ro omnidirectionally.

FIG. 10B is a schematic explanatory view of a comparative example capable of wirelessly charging and driving a mobile phone and a notebook computer in a near field.

FIG. 10C is a schematic explanatory view of a charging AC adaptor capable of charging and driving a mobile phone and a notebook computer in a cord connection manner through a common connection cable.

FIG. 11 is a schematic circuit diagram of a conventional dedicated cable connection charging AC adaptor using an iron core insulating transformer (magnetic core transformer).

FIG. 12 is a schematic circuit diagram of a conventional charging AC adaptor with a chopper type charger using a ferrite core high frequency transformer.

### DETAILED DESCRIPTION

An embodiment of the present disclosure will now be described with reference to the drawings. Throughout the drawings, the same or similar elements are denoted by the same or similar reference numerals. It should be noted that figures of the drawings are just schematic and are different in reality. It should be also understood that the figures include portions having different numerical relationships and ratios.

The following embodiment is to illustrate apparatuses and methods embodying the principles of the present disclosure and is not intended to be limited to the arrangement of elements which are described in the specification. The embodiment of the present disclosure may have various modifications according to the claims.

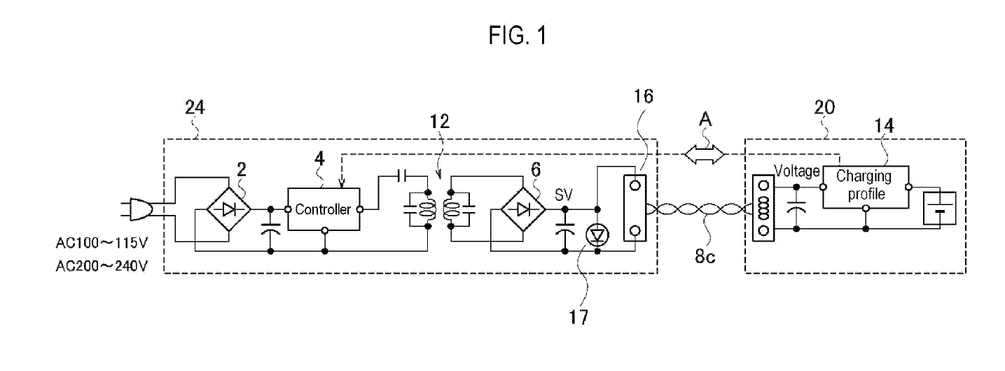

FIG. 1 is a schematic circuit diagram of a charging AC adaptor 24 to which an insulating air core transformer formed by a conductive pattern on a board is applied, according to an embodiment of the present disclosure. As shown in FIG. 1, the charging AC adaptor 24 according to the embodiment includes a first diode bridge 2 connected to an AC terminal of, for example, AC 100 to 115 V or AC 200 to 240 V, a chopper controller 4 connected to the first diode bridge 2, an insulating air core transformer 12 connected to the chopper controller 4, a second diode bridge 6 connected to a secondary side of the insulating air core transformer 12, a DC output terminal 16 connected to the second diode bridge 6, and a common connection cable 8c connected to the DC output terminal 16. The charging AC adaptor 24 is connected to a portable device such as a notebook computer 20 or the like including, for example, a charging profile integrated circuit (IC) 14 via the common connection cable 8c.

In the charging AC adaptor 24 according to the embodiment, a voltage obtained by bridge-rectifying an AC voltage of the AC terminal by means of the first diode bridge 2 is converted into a low voltage in the chopper controller 4. Accordingly, the charging AC adaptor 24 according to the embodiment has an automatic voltage adjustment function (AutoVolt) corresponding to an AC input of the AC voltage.

The charging AC adaptor 24 according to the embodiment can determine an input DC voltage of the portable device and supply a supply voltage adjusted to the input DC voltage to the portable device, so that a connection cable having no voltage dependency can be applied. Thus, the shape of the connection cable can be standardized. This allows the charging AC adaptor 24 according to the embodiment to be used in common for various kinds of portable devices.

In the charging AC adaptor 24 according to the embodiment, power loss due to no-load driving of leakage inductance when a portable device is not connected to the charging AC adaptor 24 is reduced, power is not consumed except for detection by polling of a connected portable device, and an LED indicator 17 is turned on only during a charging operation, thereby reducing average standby power to 1 mW or less.

In addition, when a portable device is connected to the charging AC adaptor 24 according to the embodiment, the portable device can transmit feedback information including detection information of the input voltage to the charging AC adaptor 24 via the common connection cable 8c and the charging AC adaptor 24 can receive the feedback information via the DC output terminal 16 and transmit it to the chopper controller 4 via the insulating air core transformer 12. That is, bi-directional communication can be conducted between the chopper controller 4 and the charging profile IC 14, as indicated by an arrow A in FIG. 1.

In the charging AC adaptor 24 according to the embodiment, the chopper controller 4 controls a tuning by detecting a primary side resonance frequency and a secondary side resonance frequency of the insulating air core transformer 12.

In addition, the charging AC adaptor 24 according to the embodiment is slightly larger than but is as light as a conventional mobile phone charging AC adaptor, while being smaller than a conventional notebook computer charging AC adaptor. The charging AC adaptor 24 according to the embodiment has an advantage in that it is fixedly installed in a home/school/office and is not moved along with portable devices, and typical portable information devices can all be charged/driven in common

### (Insulating Air Core Transformer by Conductive Pattern on Board)

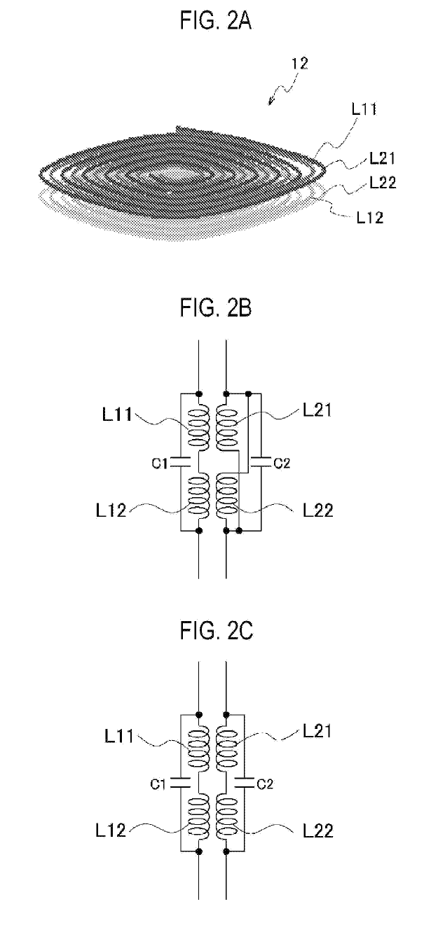

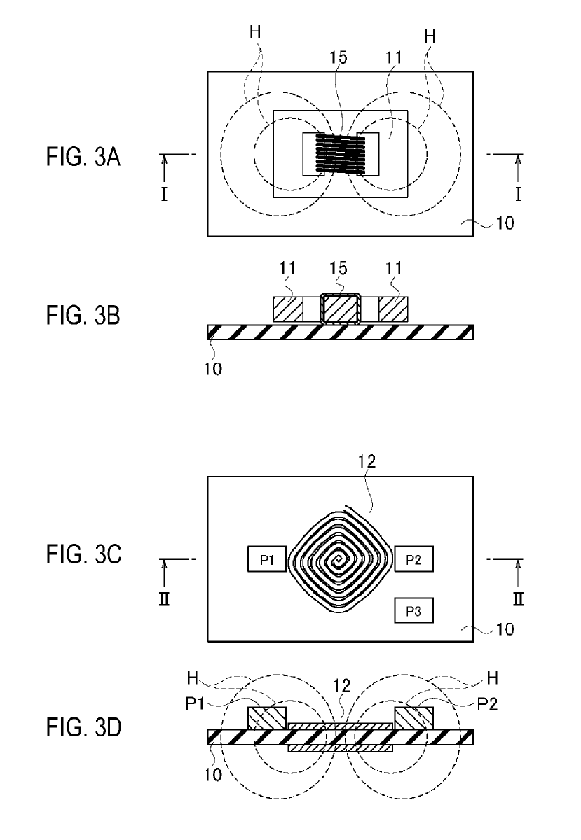

FIG. 2A is a schematic perspective view of the insulating air core transformer 12 applied to the charging AC adaptor 24 according to the embodiment. FIG. 2B is an exemplary equivalent circuit diagram of FIG. 2A, with additional parallel resonance capacitors. FIG. 2C is another equivalent circuit diagram of FIG. 2A, with additional parallel resonance capacitors. A board 10 (shown in FIGS. 3A to 3D) is not shown in FIG. 2A.

Referring to FIG. 2A, the insulating air core transformer 12 is formed on both sides of a printed circuit board (not shown). A magnetic coupling coefficient k is about 0.85 when the thickness of the printed circuit board is about 0.8 mm. As shown in FIG. 2A, in order to maintain this magnetic coupling coefficient k, a conductive pattern having a double spiral structure is formed on each side of the printed circuit board. Impedance matching includes a 1:1 connection and 2:1 connection and this topology requires no jumper. In addition, since this board pattern transformer is used with resonance, the magnetic coupling coefficient k may not be necessarily close to 1.

Further, as shown in FIG. 2A, the insulating air core transformer 12 applied to the charging AC adaptor 24 according to the embodiment includes the board 10 (see FIG. 3C), a primary coil L11 and a secondary coil L21 which are arranged on a front surface of the board 10 and are formed of a pattern of conductive layers having a spiral shape of a plurality of winding turns, and a primary coil L12 and a secondary coil L22 which are arranged on a rear surface opposite to the front surface of the board 10 and are formed of a pattern of conductive layers having a spiral shape of a plurality of winding turns.

Although it is illustrated in FIG. 2A that the number of winding turns n of the spiral-shaped conductive pattern arranged on the front and rear surfaces of the board 10 is 2, the number of winding turns n is not limited to 2 but may be 3 or more.

Although not shown, the primary coils L11 and L12 formed on the front and rear surfaces of the board 10 are connected to each other via a through hole formed in the board 10 and, similarly, the secondary coils L21 and L22 formed on the front and rear surfaces of the board 10 are connected to each other via another through hole formed in the board 10.

In addition, as shown in FIG. 2B or 2C, the insulating air core transformer 12 constitutes a double tuned circuit by connecting resonance capacitors C1 and C2 to the primary coils L11 and L12 and the secondary coils L21 and L22, respectively. FIG. 2B shows an example of a parallel connection of the secondary coils L21 and L22, and FIG. 2C shows an example of a serial connection of the secondary coils L21 and L22.

### (Effect of Opened Magnetic Circuit on Parts Mounted in Charger)

FIG. 3A is a schematic plan view of a comparative example where a ferrite core high frequency transformer 11 is arranged on a board 10. FIG. 3B is a schematic structural sectional view taken along line I-I in FIG. 3A. FIG. 3C is a schematic plan view showing an arrangement of the insulating air core transformer 12 which is formed by the conductive pattern on the board and is applied to the charging AC adaptor 24 according to the embodiment of the present disclosure. FIG. 3D is a schematic structural sectional view taken along line II-II in FIG. 3C.

The ferrite core high frequency transformer 11 as a closed magnetic circuit using a ferrite core in the comparative example basically differs from the insulating air core transformer 12 in that the former is a wide band transformer having more magnetic fluxes, whereas the latter, as an opened magnetic circuit, is a narrow band transformer having fewer magnetic fluxes. As a result, the charging AC adaptor 24 according to the embodiment can suppress the effect of a leakage magnetic flux on adjacent mounted parts P1 to P3, i.e., an effect of a leakage magnetic flux on mounted parts of the charging AC adaptor 24.

In addition, due to the existence of the adjacent mounted parts P1 to P3, the wide band ferrite core high frequency transformer 11 of the comparative example has low variation of its operating point while the insulating air core transformer 12 applied to the charging AC adaptor 24 according to the embodiment has the tendency of a shift of its resonance frequency. However, these effects are automatically absorbed to not provide a problem.

A conventional non-contact charger of a closed magnetic circuit attempts to reduce the leakage magnetic flux as possible but the charging AC adaptor 24 of an opened magnetic circuit according to the embodiment can suppress the effect of a leakage magnetic flux on the mounted parts. That is, in the charging AC adaptor 24 according to the embodiment, by making a tuning with the addition of the resonance capacitors C1 and C2 to the primary coils L11 and L12 and the secondary coils L21 and L22, respectively, excitation inductance in the air coil is equivalently multiplied by Q and the primary coils L11 and L12 and the secondary coils L21 and L22 are coupled to each other with extremely low impedance. This prevents an effect of impedance as a short ring of adjacent alien substance.

In the charging AC adaptor 24 according to the embodiment, the insulating air core transformer 12 has a magnetic coupling coefficient of 0.8 or more and an unloaded Q value of 50 or more. As a result, a total power transmission efficiency of 80% or more can be maintained.

The board 10 may be, for example, a printed circuit board.

A typical printed circuit board increases in terms of its series resistance when an insulating air core transformer having a conductive pattern is formed on the board since the thickness of a conductive layer is set to, for example, 35 μm. Accordingly, an insertion loss of a high frequency insulating transformer may be reduced by increasing the thickness of the conductive layers of both front and rear surfaces of the printed circuit board using a process of attaching copper with electro-plating in a through hole forming process of two or more layers of printed circuit boards in order to alleviate an increase of the insertion loss of the high frequency insulating transformer.

### (Equivalent Circuit of Power Transmission)

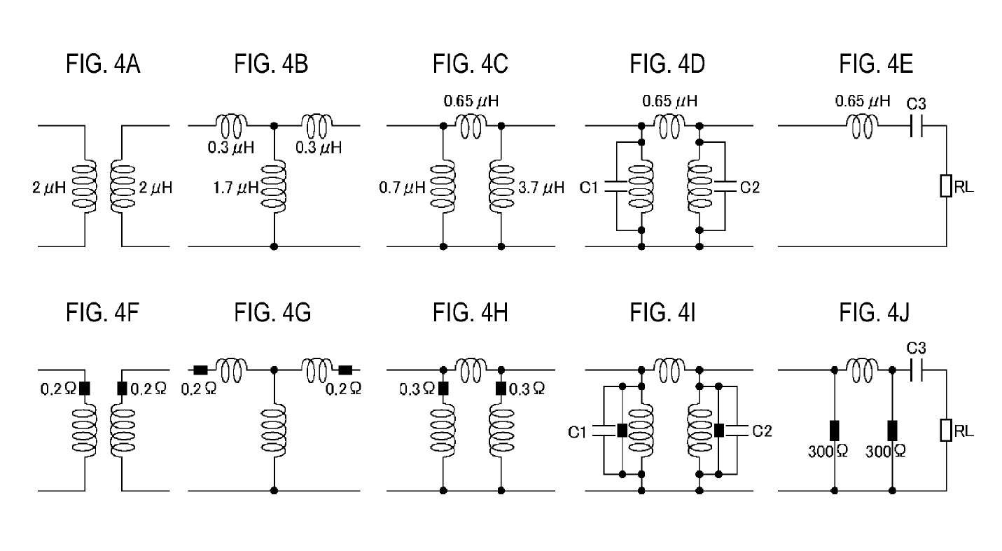

FIG. 4A is a basic equivalent circuit diagram of the insulating air core transformer 12 applied to the charging AC adaptor 24 according to the embodiment of the present disclosure. FIG. 4B is a T type equivalent circuit diagram of FIG. 4A, and FIG. 4C is a Delta-Star transform equivalent circuit diagram of FIG. 4B. FIG. 4D is a parallel resonance equivalent circuit diagram with additional parallel resonance capacitors C1 and C2, and FIG. 4E is a series resonance equivalent circuit diagram with an additional series resonance capacitor C3. As shown in FIG. 4D, with the addition of the parallel resonance capacitors C1 and C2 to the primary side and the secondary side, excitation inductance is increased by Q times. When leakage inductance left finally is removed by using the series resonance capacitor C3 as shown in FIG. 4E, all reactance components of the transformer are removed to overcome the problem of low excitation inductance, thereby achieving high excitation impedance.

Whereas a conventional transformer concept has pursued an ideal transformer operating in a wide band, the insulating air core transformer 12 applied to the charging AC adaptor 24 according to the embodiment can operate in an extremely narrow single frequency band with complete exclusion of this concept.

FIG. 4F is an equivalent circuit diagram with losses included to FIG. 4A, FIG. 4G is an equivalent circuit diagram with losses included to FIG. 4B, FIG. 4H is an equivalent circuit diagram with losses included to FIG. 4C, FIG. 41 is an equivalent circuit diagram with losses included to FIG. 4D, and FIG. 4J is an equivalent circuit diagram with losses included to FIG. 4E. The thickness of a pattern of conductive layers on a typical printed circuit board is, for example, about 35 μm, as described above, and the conductivity of copper is 58E6S/m.

The insulating air core transformer 12 applied to the charging AC adaptor 24 according to the embodiment can achieve high excitation impedance by adding the resonance capacitors, as shown in FIGS. 4F and 4J.

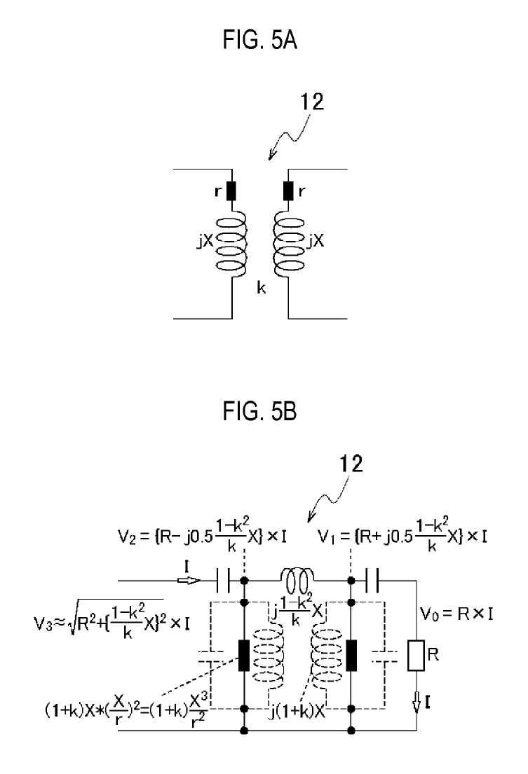

FIG. 5A is an equivalent circuit diagram corresponding to FIG. 4F when winding reactance is X, a magnetic coupling coefficient between a primary coil and a secondary coil is k, and winding resistance is r in the insulating air core transformer 12 applied to the charging AC adaptor 24 according to the embodiment. FIG. 5B is an equivalent circuit diagram corresponding to FIG. 4I or FIG. 4J when a load resistance R is connected. In the insulating air core transformer 12 applied to the charging AC adaptor 24 according to the embodiment, operation constants around the transformer are as shown in FIG. 5B and reactance X at a resonance point disappears due to the capacitors C1 and C2. Accordingly, the insulating air core transformer 12 can be used in the same manner as a magnetic core transformer due to a resonance.

From the standpoint of a conventional concept of transformer design, a first defect of an air core is that excitation inductance becomes small and accordingly current flows into the air core to prevent power from being delivered to a secondary side. However, this can be easily overcome by increasing excitation impedance at a tuning frequency by Q times through the resonance.

A second defect of the air core is that a magnetic coupling coefficient is smaller than that of a cored transformer since the air core transformer is an opened magnetic circuit. However, this can be also overcome by the resonance.

A third defect of the air core is that a magnetic flux is leaked having an effect on other mounted parts on a single board of a charger since the air core transformer is an opened magnetic circuit. However, this can be relatively overcome since the primary and secondary sides have low impedance. There is no defect of the air core other than these defects.

### (Power Transmission Efficiency)

Power transmission efficiency η of the resonance type insulating air core transformer 12 applied to the charging AC adaptor 24 according to the embodiment is approximately expressed by Equation 1.

$$η \approx 1 - \frac{2 \frac{{\vert R - j 0.5 \frac{1 - {k}^{2}}{k} X \vert}^{2} * {I}^{2}}{( 1 + k ) \frac{{X}^{3}}{{r}^{2}}}}{R * {I}^{2}} = 1 - \frac{2 {\vert R - j 0.5 \frac{1 - {k}^{2}}{k} X \vert}^{2}}{R * ( 1 + k ) \frac{{X}^{3}}{{r}^{2}}} \qquad [ Equation 1 ]$$

In the above equation, X is winding reactance, k is a magnetic coupling coefficient between the primary coil and the secondary coil, r is winding resistance and R is load resistance. A symbol * represents multiplication.

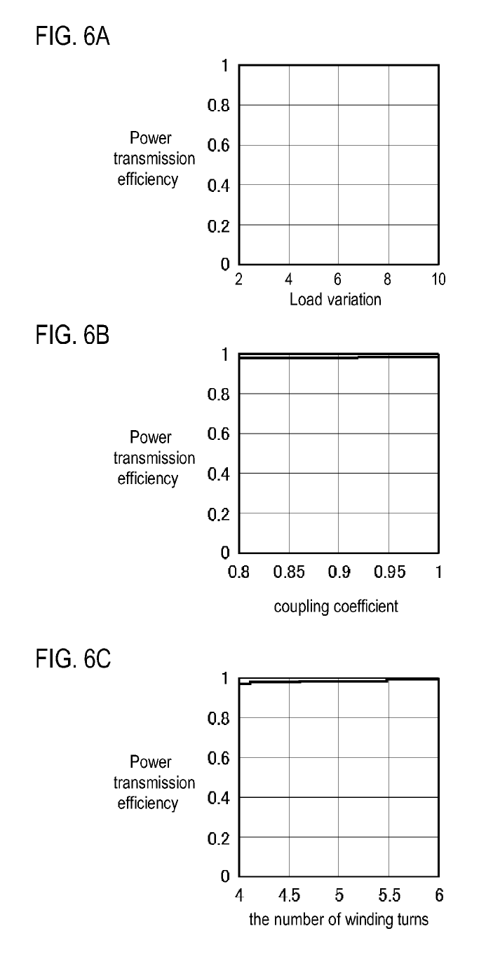

FIG. 6A shows power transmission efficiency when load variation is 2 W to 10 W in the insulating air core transformer applied to the charging AC adaptor 24 according to the embodiment, FIG. 6B shows power transmission efficiency when a magnetic coupling coefficient is changed from 0.8 to 2.0, and FIG. 6C shows power transmission efficiency when the number of winding turns n is changed from 4 to 6 in the insulating air core transformer where a diameter thereof remains unchanged. As apparent from FIGS. 6A to 6C, it can be seen that an insertion loss may be ignored by considering resistance r based on a magnetic coupling coefficient k and a copper loss of the insulating air core transformer 12 which can be obtained with a typical board pattern.

The charging AC adaptor 24 according to the embodiment can achieve a reduction of cost by forming the insulating air core transformer 12 with a conductive pattern on the printed circuit board. In addition, by subjecting a feedback from the secondary side to the primary side of the insulating air core transformer 12 to carrier modulation through the insulating air core transformer 12 from a photo-coupler, the number of parts and costs can be reduced. In addition, since the charging AC adaptor 24 is not required to be packed with a portable information device, by using the standardized charging AC adaptor 24 in common, reduction of costs can be achieved.

The charging AC adaptor 24 used in common according to the embodiment may be available at a low price and can charge/drive a portable device of, for example, 3 W to 10 W. In addition, the charging AC adaptor 24 may be left in a home/school/office without being carried and may be shared between persons with mutual concessions.

The charging AC adaptor 24 used in common according to the embodiment is slightly larger than an existing mobile phone charger while being smaller and lighter than an existing notebook computer charging AC adaptor.

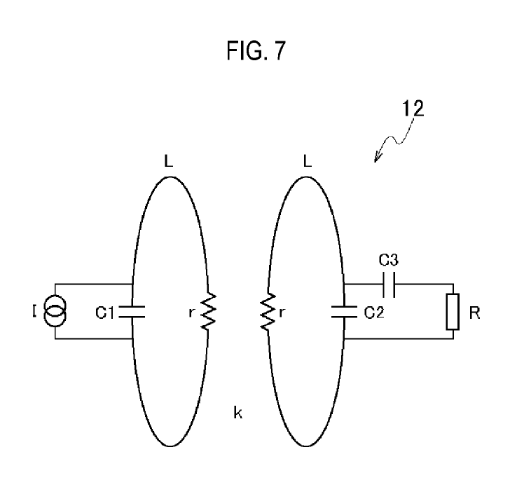

FIG. 7 is an exemplary circuit diagram of the insulating air core transformer 12 applied to the charging AC adaptor 24 according to the embodiment. In FIG. 7, an average radius of the primary and secondary coils is about 2 cm, the number of coil winding turns n is 10, inductance L of the primary coil is 2 μH, parallel resonance capacitance C1 is 12 nF, resistance r is 0.3Ω, inductance L of the secondary coil is 2 μH, parallel resonance capacitance C2 is 12 nF, resistance r is 0.3Ω, a magnetic coupling coefficient k is 0.85, series resonance capacitance C3 is 150 nF and load resistance R is 6Ω.

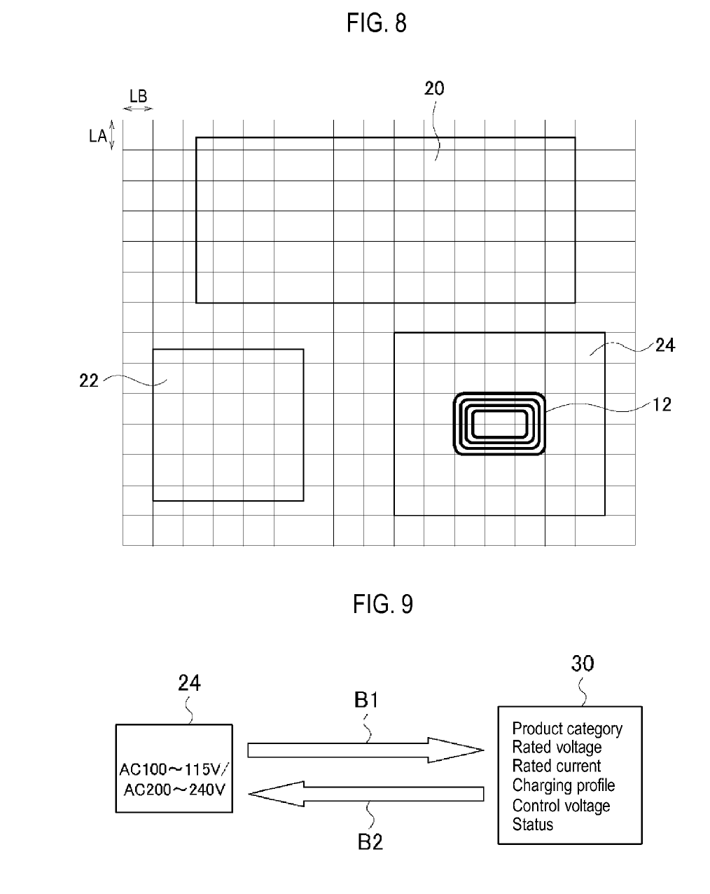

FIG. 8 shows an example of the dimensions of the charging AC adaptor 24 according to the embodiment, a mobile phone 22 to be charged, and a notebook computer 20 to be charged. The dimension of the charging AC adaptor 24 is about 6 LA×7 LB, while the dimension of the portable phone 22 is about 5 LA×5 LB and the dimension of the notebook computer 20 is about 5.5 LA×12.5 LB.

FIG. 9 is a block diagram for explaining an aspect of bi-directional communication between the charging AC adaptor 24 according to the embodiment and a portable device 30. A DC voltage automatically voltage-adjusted by matching AC 100 to 115 V/AC 200 to 240 V to product category/rated voltage/rated current is supplied from the charging AC adaptor 24 according to the embodiment to the portable device 30, as indicated by an arrow B1. On the other hand, information of a charging profile IC/control signal/status is delivered from the portable device 30 to the charging AC adaptor 24 according to the embodiment, as indicated by an arrow B2.

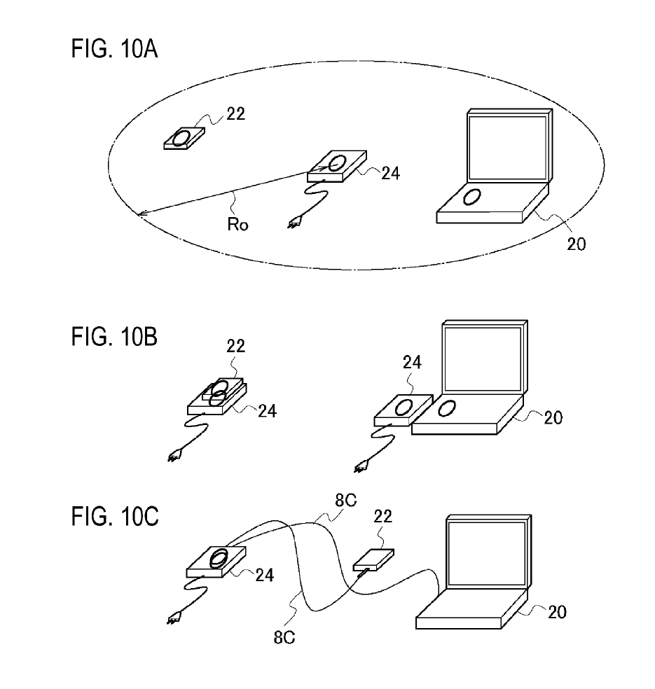

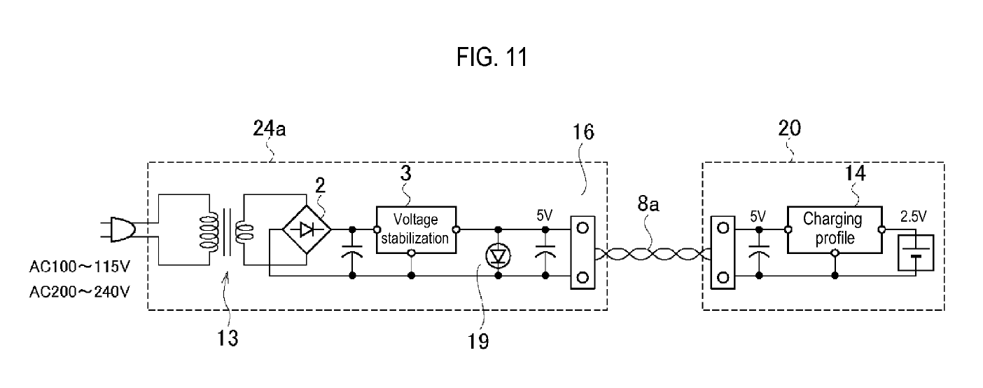

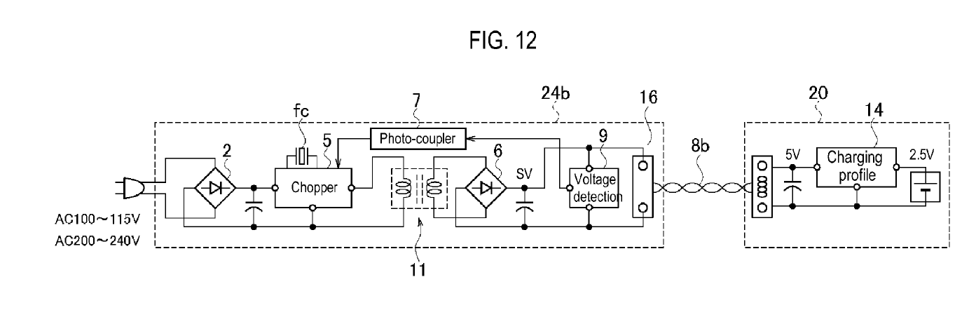

FIG. 10A shows a comparative example of a common portable device charging technique capable of wirelessly charging and driving a mobile phone 22 and a notebook computer 20 within a spherical surface having a radius of Ro omnidirectionally. The comparative example of FIG. 10A provides efficiency of about 50% while wirelessly charging and driving the mobile phone 22 and the notebook computer 20 within a spherical surface having a radius of Ro=3 m omnidirectionally.

FIG. 10B shows another comparative example of a common portable device charging technique capable of wirelessly charging and driving a mobile phone 22 and a notebook computer 24 in a near field. The comparative example of FIG. 10B provides improved efficiency of about 70% while wirelessly charging and driving the mobile phone 22 and the notebook computer 24 in the near field.

FIG. 10C is a schematic view of the charging AC adaptor 24 of the embodiment capable of charging and driving a mobile phone 22 and a notebook computer 20 in a cord connection manner through the common connection cable 8c. The charging AC adaptor 24 of the embodiment can provide efficiency of 80% or more while charging and driving the mobile phone 22 and the notebook computer 20 in the cord connection manner through the common connection cable 8c.

With application of the insulating air core transformer 12 instead of a ferrite core high frequency transformer, the charging AC adaptor 24 according to the embodiment can improve the trade-off between compactness of the high frequency transformer and power loss of a transistor performing a switching operation with a chopper frequency.

In addition, by standardizing connectors connecting a portable device and the charging AC adaptor 24 and relevant protocols, the charging AC adaptor 24 according to the embodiment can be used in common in portable devices including a mobile phone and a notebook without relying on the types of portable devices.

In addition, the charging AC adaptor 24 according to the embodiment can provide bi-directional communication between a charging profile IC of a portable device and the chopper controller 4 of the charging AC adaptor 24 via a standardized cable and an insulating air transformer.

The charging AC adaptor 24 according to the embodiment can standardize a charging/driving method of a portable device and maintain power transmission efficiency by an insulating air core transformer formed by a conductive pattern on a board, thereby suppressing the effect of a leakage magnetic flux on mounted parts of the charging AC adaptor 24.

The charging AC adaptor 24 according to the embodiment can be significantly reduced in its production costs by using a charging AC adaptor/charger of a portable device in common for other portable devices including a mobile phone and a notebook computer with any voltage/current, standardizing cables/connectors/protocols, and forming the insulating air core transformer 12 with a conductive pattern on a printed circuit board.

The present disclosure can provide a charging AC adaptor which is capable of being used in common for various portable devices including mobile phones and notebook computers incorporating a charging battery, maintaining power transmission efficiency and suppressing the effect of a leakage magnetic flux on mounted parts of the charging AC adaptor.

Although the present disclosure has been described by way of an embodiment, the description and the drawings, both of which are parts of the specification, are not intended to limit the present disclosure. It is apparent to those skilled in the art that the present disclosure may be modified and changed in different forms of embodiments, examples and operation techniques.

According to the present disclosure, it is possible to provide a charging AC adaptor which is capable of being used in common for portable devices including mobile phones and notebook computers incorporating a charging battery, maintaining power transmission efficiency and suppressing the effect of a leakage magnetic flux on mounted parts of the charging AC adaptor.

The charging AC adaptor according to the above embodiment can be applied to various portable devices since it is fixedly installed in a home/school/office and is not moved along with the portable devices. Typical portable information devices can all be charged/driven in common by the charging AC adaptor of the present disclosure.

While a certain embodiment has been described, this embodiment has been presented by way of example only, and is not intended to limit the scope of the disclosures. Indeed, the novel methods and apparatuses described herein may be embodied in a variety of other forms; furthermore, various omissions, substitutions and changes in the form of the embodiment described herein may be made without departing from the spirit of the disclosures. The accompanying claims and their equivalents are intended to cover such forms or modifications as would fall within the scope and spirit of the disclosures.

What is claimed is:

1. A charging AC adaptor comprising:
a first diode bridge connected to an AC terminal;
a chopper controller connected to the first diode bridge;
an insulating air core transformer connected to the chopper controller;
a second diode bridge connected to a secondary side of the insulating air core transformer;
a DC output terminal connected to the second diode bridge; and
a common connection cable connected to the DC output terminal,
wherein the charging AC adaptor is connectable to a portable device via the common connection cable.

2. The charging AC adaptor of claim 1, wherein the insulating air core transformer includes:
a board;
a primary coil and a secondary coil which are arranged on a front surface of the board and are formed of a pattern of conductive layers having a spiral shape of a plurality of winding turns; and
a primary coil and a secondary coil which are arranged on a rear surface opposite the front surface of the board and are formed of a pattern of conductive layers having a spiral shape of a plurality of winding turns.

3. The charging AC adaptor of claim 2, wherein the insulating air core transformer constitutes a double tuned circuit by connecting resonance capacitors to the primary coils and the secondary coils, respectively.

4. The charging AC adaptor of claim 3, wherein the insulating air core transformer has a magnetic coupling coefficient of 0.8 or more and an unloaded Q value of 50 or more.

5. The charging AC adaptor of claim 2, wherein the chopper controller controls a tuning by detecting a primary side resonance frequency and a secondary side resonance frequency of the insulating air core transformer.

6. The charging AC adaptor of claim 1, wherein a voltage obtained by bridge-rectifying an AC voltage of the AC terminal by means of the first diode bridge is converted into a low voltage in the chopper controller.

7. The charging AC adaptor of claim 1, wherein the charging AC adaptor determines an input DC voltage of the portable device and supplies a supply voltage adjusted to the input DC voltage to the portable device, so that a shape of the common connection cable having no voltage dependency can be standardized to allow the charging AC adaptor to be used in common for various kinds of portable devices.

8. The charging AC adaptor of claim 1, wherein, when the portable device is connected to the charging AC adaptor, the portable device transmits feedback information including detection information of the input voltage to the charging AC adaptor via the common connection cable and the charging AC adaptor receives the feedback information via the DC output terminal and transmits the received feedback information to the chopper controller via the insulating air core transformer.
